(19) United States
(12) Patent Application Publication
(10) Pub. No.: US 2015/0146406 A1
(43) Pub. Date: May 28, 2015

(54) BLUE LIGHT MIXING METHOD AND SYSTEM USING THE SAME

(71) Applicant: DELTA ELECTRONICS, INC., KUEI SAN (TW)

(72) Inventors: Keh-Su CHANG, Kuei San (TW); Yen-I CHOU, Kuei San (TW); Chi CHEN, Kuei San (TW); Jau-Shiu CHEN, Kuei San (TW); Meng-Han LIU, Kuei San (TW)

(21) Appl. No.: 14/297,964

(22) Filed: Jun. 6, 2014

(30) Foreign Application Priority Data
Nov. 28, 2013 (TW) 102143386

(51) Int. Cl. F21V 9/08; F21V 13/08

(52) U.S. Cl. CPC F21V 9/08; F21V 13/08; G02B 27/141
USPC 362/84

(57) ABSTRACT

A blue light mixing method includes the steps of: providing a blue laser; disposing a wavelength conversion device on the light path of the blue laser wherein a part of the blue laser excites the wavelength conversion device to emit a wavelength-modulated blue light; and mixing the blue laser that hasn't undergone the wavelength modulation and the wavelength-modulated blue light.

### CROSS REFERENCE TO RELATED APPLICATIONS

This Non-provisional application claims priority under 35 U.S.C. §119(a) on Patent Application No(s). 102143386 filed in Taiwan, Republic of China on Nov. 28, 2013, the entire contents of which are hereby incorporated by reference.

### BACKGROUND OF THE INVENTION

1. Field of Invention

The invention relates to a light mixing method and a system and, in particular, to a blue light mixing method and a system.

2. Related Art

A projector can produce colorful images by assigning a proper proportion to the three primary colors (RGB). Generally, the said proportion can be determined by the white balance calibration, and the proportion of the blue light has a great influence on the white balance color coordinates and the color temperature point. As to the color mixing of red, green and blue, the proportion of the blue light is 10% enough to fit the commonly-used white balance standard, and the remaining portion of 90% can be mainly composed of the red light and green light. In other words, therefore, the proportion of the blue light determines the brightness of the white image of the projector.

A laser projector commonly uses the blue laser as the main blue light source, which is different from the conventional lamp using a color filter or a blue light source using a blue LED. However, when the blue laser serves as the blue light source of a projector, the color gamut of the projector can not completely encompass the standard gamut of Rec. 709 and the color variety is thus reduced. Moreover, since the portion of the blue light source is provided mainly by the blue laser, the wattage of the laser will be increased with the increasingly advanced product specifications. In this case, the product with high brightness will unavoidably undergo the problems of too much remaining laser and unfitness for the security standard of the laser product.

Therefore, it is an important subject to provide a blue light mixing method and a system which use the mixed blue light as the blue light source so that the gamut of the system can encompass the standard gamut of Rec. 709 and the security standard of the laser product can be fit.

### SUMMARY OF THE INVENTION

In view of the foregoing subject, an objective of the invention is to provide a blue light mixing method and a system which can fit the Rec. 709 standard and the security standard of the laser product (IEC-60825-1).

To achieve the above objective, a blue light mixing method according to the invention includes the steps of: providing a blue laser; disposing a wavelength conversion device on the light path of the blue laser wherein a part of the blue laser excites the wavelength conversion device to emit a wavelength-modulated blue light; and mixing the blue laser that hasn't undergone the wavelength modulation and the wavelength-modulated blue light.

In one embodiment, before the step of mixing light, the blue light mixing method further comprises a step of: attenuating or partially filtering out the blue laser that hasn't undergone the wavelength modulation.

In one embodiment, the wavelength conversion device includes a transparent region, and the wavelength conversion material is disposed in the area except the transparent region.

In one embodiment, at least a part of the blue laser that hasn't undergone the wavelength modulation passes through the transparent region.

In one embodiment, the wavelength conversion device includes a color wheel.

In one embodiment, the wavelength conversion material includes a fluorescent material, a phosphorescent material or their combination.

In one embodiment, the fluorescent material includes a silicone compound.

In one embodiment, the wavelength of the blue laser is 445 nm˜448 nm, and the main wavelength of the wavelength-modulated blue light is 460 nm±5 nm.

To achieve the above objective, a blue light mixing system according to the invention comprises a light source, a wavelength conversion device and an optical element group. The light source is used to provide a blue laser. The wavelength conversion device is disposed on a light path of the blue laser. The optical element group forms the light path. A part of the blue laser excites the wavelength conversion device to emit a wavelength-modulated blue light, and the blue laser that hasn't undergone the wavelength modulation and the wavelength-modulated blue light are mixed.

In one embodiment, the optical element group includes a filter used to partially filter out the blue laser, and the wavelength-modulated blue light passes through the filter.

In one embodiment, the optical element group includes an attenuator used to partially attenuate the blue laser, and the wavelength-modulated blue light passes through the attenuator.

In one embodiment, the optical element group includes a dichroic mirror used to reflect the blue laser, and the wavelength-modulated blue light passes through the dichroic mirror.

In one embodiment, the wavelength conversion device includes a transparent region, and a wavelength conversion material is disposed in the area except the transparent region.

In one embodiment, at least a part of the blue laser that hasn't undergone the wavelength modulation passes through the transparent region.

In one embodiment, the wavelength conversion device includes a color wheel.

In one embodiment, the wavelength conversion material includes a fluorescent material, a phosphorescent material or their combination.

In one embodiment, the fluorescent material includes a silicone compound.

In one embodiment, the wavelength of the blue laser is 445 nm˜448 nm, and the main wavelength of the wavelength-modulated blue light is 460 nm±5 nm.

As mentioned above, in the blue light mixing method and system of the invention, a part of the blue laser excites the wavelength-modulated blue light, and another part of the blue laser is mixed with the wavelength-modulated blue light to generate the blue light source fitting the Rec. 709 standard and the security standard of the laser product (IEC-60825-1).

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic flowchart of a blue light mixing method according to an embodiment of the invention;

FIG. 2 is a schematic diagram showing the spectrum of the fluorescent light;

FIGS. 3A and 3B are schematic diagrams of the wavelength conversion devices according to an embodiment of the invention;

FIG. 4A is a schematic diagram showing the spectrum of the blue laser;

FIG. 4B is a schematic diagram showing the spectrum of the blue laser, the filter and the attenuator;

FIG. 4C is a schematic diagram showing the spectrum of the mixed blue light;

FIG. 5 is a schematic diagram of a blue light mixing system according to an embodiment of the invention; and

FIG. 6 is a schematic diagram of a blue light mixing system according to another embodiment of the invention.

### DETAILED DESCRIPTION OF THE INVENTION

The present invention will be apparent from the following detailed description, which proceeds with reference to the accompanying drawings, wherein the same references relate to the same elements.

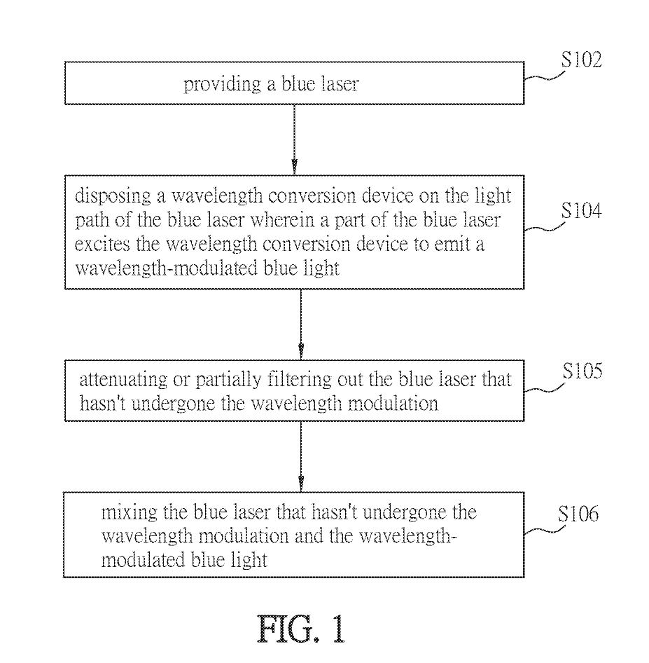

FIG. 1 is a schematic flowchart of a blue light mixing method according to an embodiment of the invention. As shown in FIG. 1, the blue light mixing method includes the steps of: providing a blue laser (S102); disposing a wavelength conversion device on the light path of the blue laser, wherein a part of the blue laser excites the wavelength conversion device to emit a wavelength-modulated blue light (S104); mixing the remaining blue laser and the wavelength-modulated blue light (S106). The blue light mixing method can be applied to, for example, an illumination system, a projector, a display or other optical apparatuses, and the laser projector is taken as an example in this embodiment.

In the step S102, the blue laser can be provided by a gas laser, a solid-state laser, a fiber laser or a semiconductor laser for example, and this invention is not limited thereto. In this embodiment, in addition to serving as the excitation light source, the blue laser also provides the light mixing purpose. Currently, the wavelength of the blue laser provided by a laser in the market mostly ranges between 445 nm and 448 nm, which is applied to this embodiment in order to reduce the cost of light mixing. Accordingly, there is no need to specially make a laser with a specific wavelength so the cost can be reduced. However, the wavelength of the blue laser is not limited in this invention, as long as the required mixed blue light can be obtained.

In the step S104, a wavelength conversion device is disposed on the light path of the blue laser, and a part of the blue laser excites the wavelength conversion device to emit a wavelength-modulated blue light. The wavelength conversion device contains a wavelength conversion material. The wavelength conversion device is a color wheel favorably. In this embodiment, when the blue laser is emitted to the wavelength conversion device and illuminates the wavelength conversion material, the wavelength conversion material will be excited to emit light. In this embodiment, the light emitted by the wavelength conversion material is mainly blue light with a main wavelength of 460±5 nm. The type of the wavelength conversion material can be adjusted according to the light with the required wavelength. As an embodiment, when the blue laser with the wavelength of 445 nm is used, the wavelength conversion material with the wavelength of 460 nm can be used in order to effectively decrease the remaining amount of the blue laser (i.e. more suitable for the security standard of the laser product). In comparison with the conventional art where the green phosphor powder (with a main wavelength of about 550 nm) or the cyan phosphor powder (with a main wavelength of 490 nm) for the light mixing, the wavelength conversion device (with a main wavelength of 460±5 nm) used in this embodiment can effectively reduce the required amount of the blue laser.

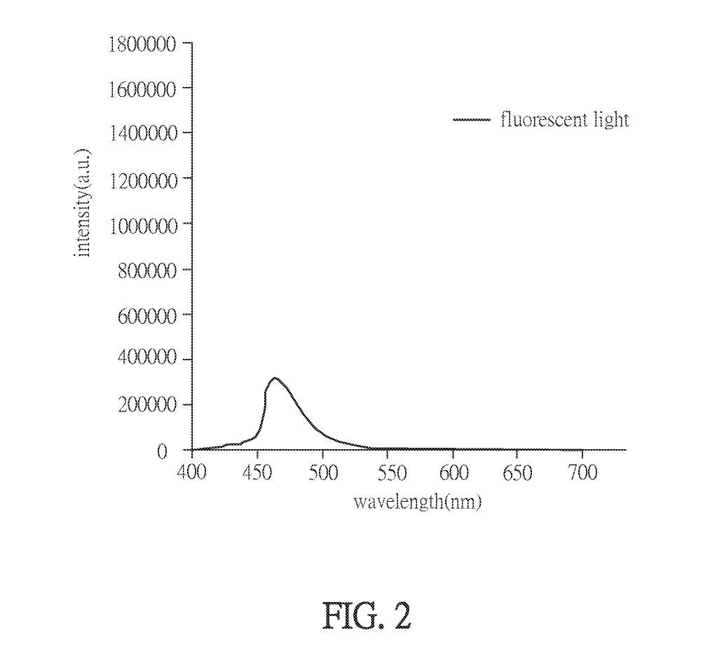

The wavelength conversion material can be a fluorescent material, a phosphorescent material or their combination. Herein for example, the fluorescent material is used and includes a silicone compound as the main constituent. The main wavelength of the fluorescent material of this embodiment is 460 nm, and the spectrum of the fluorescent light is shown as FIG. 2.

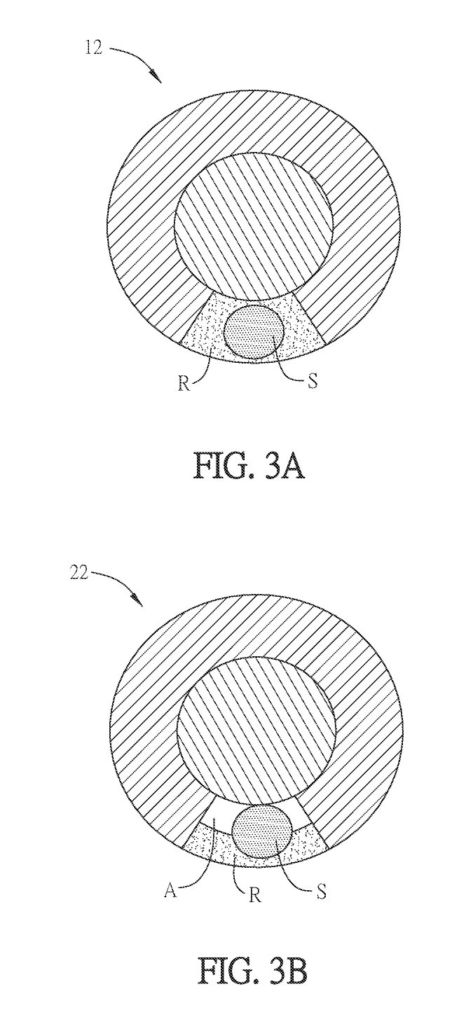

In this embodiment, the wavelength conversion device can include a transparent region, which can be formed, for example, by a transparent object such as glass or by a through hole, as long as it is permeable to light. In other embodiments, the wavelength conversion material can be disposed in the area except the transparent region. FIGS. 3A and 3B are schematic diagrams of the wavelength conversion devices 12 and 22, color wheels for example, according to an embodiment of the invention. As shown in FIG. 3A, the region R of the wavelength conversion device 12 is configured with a wavelength conversion material. When the blue laser (the region S denotes the cross-section of the incident blue laser) is emitted to the region R of the wavelength conversion device 12, although the whole blue laser illuminates the wavelength conversion material, a part of the blue laser will excite the wavelength conversion material to emit a wavelength-modulated blue light and the remaining blue laser will pass through the wavelength conversion material with the original wavelength rather than being absorbed by the wavelength conversion material. As shown in FIG. 3B, when the blue laser (the region S denotes the cross-section of the incident blue laser) is emitted to the edge of the transparent region A, since the laser beam is directional with high parallelism, a part of the blue laser will pass through and come out of the transparent region A, and another part of the blue laser will illuminate the region R configured with the wavelength conversion material to induce the excited light. In this embodiment, the excited light is blue light and favorably blue fluorescent light.

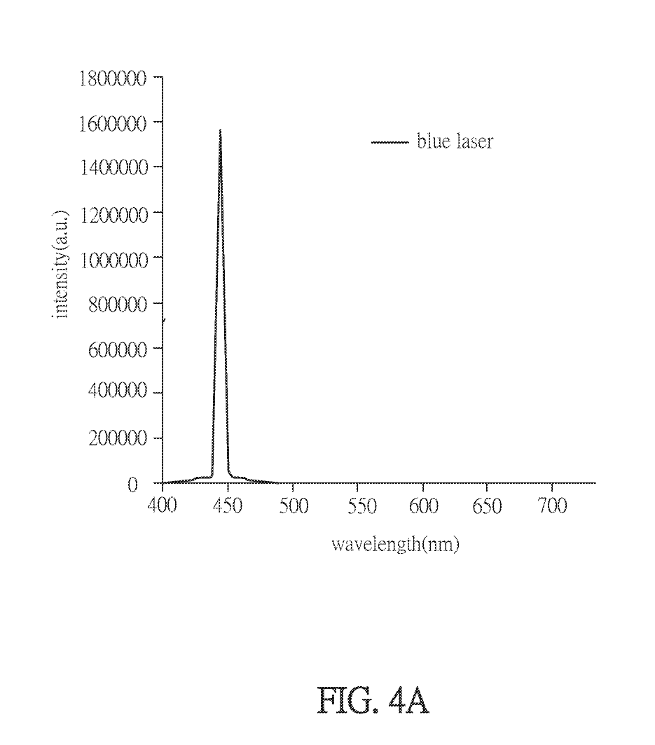

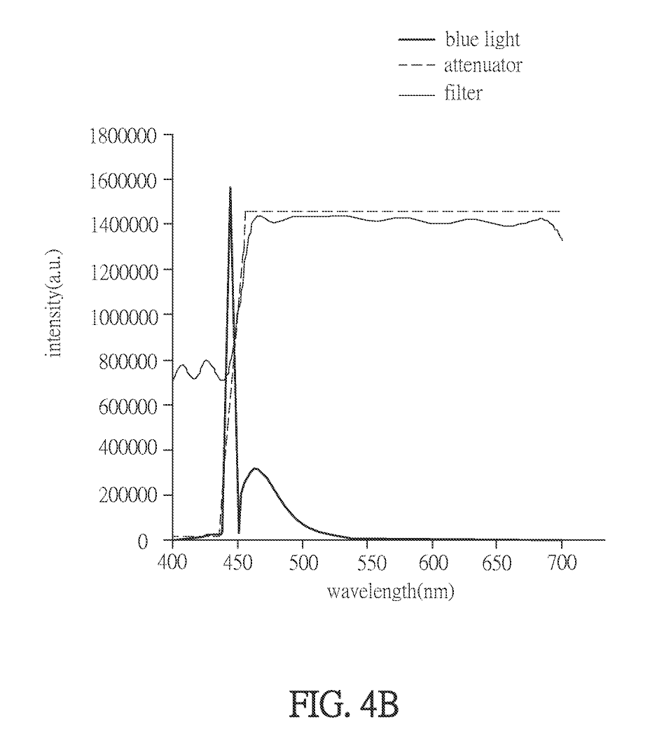

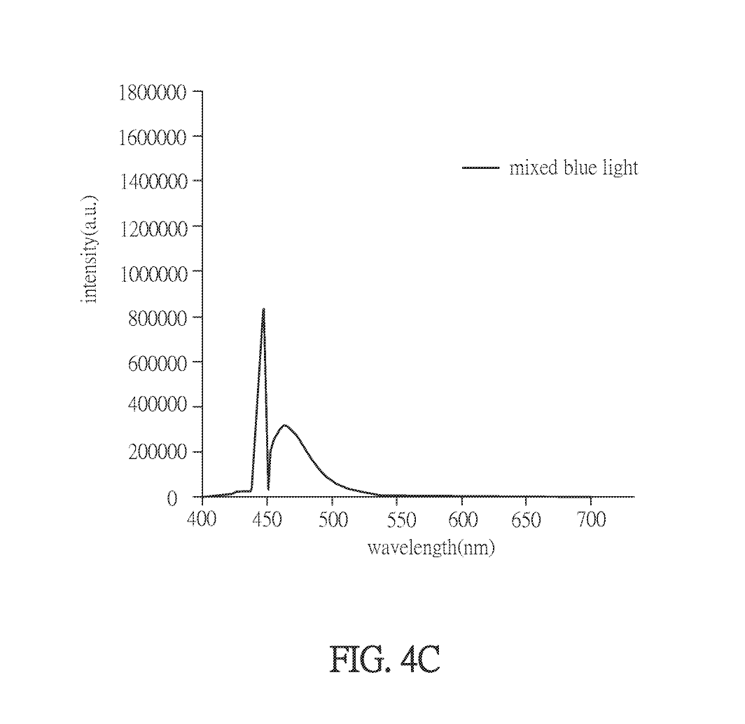

FIG. 4A is a schematic diagram showing the spectrum of the blue laser. As shown in FIG. 4A, since the blue laser coming out of the wavelength conversion device is obtained by mixing the blue laser passing through the transparent region and the wavelength-modulated blue light, the energy possessed thereby is lower than the energy of the complete blue laser, so the security standard of the laser product (IEC-60825-1) can be fit (the standard of the wattage of the blue laser is varied with the different requirement and is less than 5 mW or 2 mW for example). In other embodiments, maybe the blue laser coming out of the wavelength conversion device can't fit the above-mentioned security standard, so the blue laser can undergo an intensity attenuating step or a partial filter process, as shown in the step S105, before the step of mixing light. In this embodiment, a filter is disposed on the light path of the blue laser to filter out a part of the blue laser, 60% blue laser for example. Besides, the filter can filter out the light with the wavelength of 445 nm˜448 nm. Accordingly, the filter of this embodiment can just filter out a part of the blue laser and won't filter out the blue fluorescent light with the main wavelength of 460 nm±5 nm. To be noted, the filter of this embodiment can be replaced by an attenuator. Likewise, the attenuator can attenuate the light with the wavelength of 445 nm˜448 nm to attenuate a part of the blue laser, 60% blue laser for example, and the blue fluorescent light with the main wavelength of 460 nm±5 nm won't be attenuated by the attenuator. Herein, the filtered or attenuated blue laser has lower energy so as to fit the security standard of the laser product (IEC-60825-1). The spectrum design of the above mentioned filter/attenuator is shown in FIG. 4B, including the spectrums of the blue laser, attenuator and filter, and the filter/attenuator can remove the extra blue laser energy.

In the step S106, the blue laser that hasn't undergone the wavelength modulation and the wavelength-modulated blue light are mixed. In this embodiment, a part of the blue laser is used as the excitation light source to excite the wavelength conversion material of the wavelength conversion device to emit the blue fluorescent light. Another part of the blue laser passing through the transparent region is mixed with the excited blue fluorescent light and then the mixed blue light is used as the blue light source of the laser projector of this embodiment. Because the light mixing is implemented between the blue laser with the wavelength of 445 nm˜448 nm and the blue fluorescent light with the wavelength of 460 nm±5 nm, the obtained mixed blue light will fit the Rec. 709 standard. The spectrum of the mixed blue light is shown in FIG. 4C.

So, in this embodiment, the laser provides the blue laser, a part of the blue laser induces the excited blue fluorescent light, another part of the blue laser not for the excitation is mixed with the blue fluorescent light, and the mixed blue light is used as the blue light source of the laser projector. By the blue laser and the blue fluorescent light having the wavelengths of specific ranges, the obtained mixed blue light can just fit the Rec. 709 standard. Moreover, in other embodiments, the filter or attenuator can be used to filter out or attenuate a part of the blue laser so as to decease the energy of the blue laser and therefore the security standard of the laser product (IEC-60825-1) can be fit.

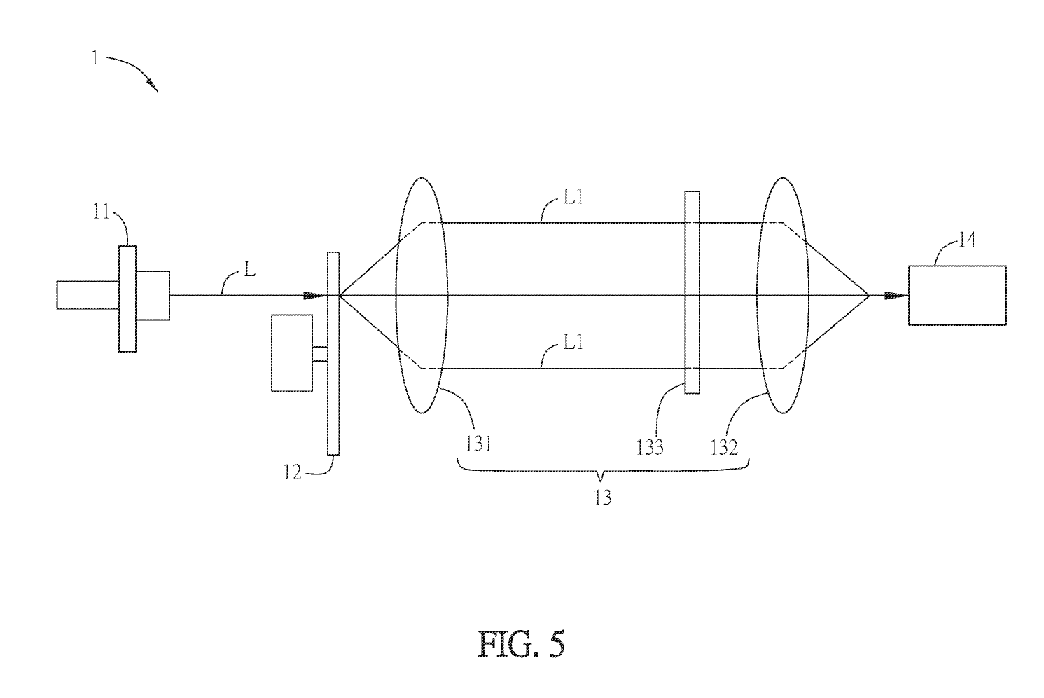

FIG. 5 is a schematic diagram of a blue light mixing system according to an embodiment of the invention. As shown in FIG. 5, the above mentioned blue light mixing method can be applied to the blue light mixing system 1. In this embodiment, the blue light mixing system 1 includes a light source 11, a wavelength conversion device 12, an optical element group 13 and an integrator rod 14. The light source 11 and the wavelength conversion device 12 (as shown in FIG. 3A) have been illustrated in the above embodiments, and therefore they are not described here for conciseness.

In this embodiment, the blue laser has a light path L. The optical element group 13 forms the light path L and includes a plurality of lenses 131, 132 and a filter/attenuator 133. The filter/attenuator 133 is disposed between the lenses 131, 132, the light source 11 is disposed on the side of the lens 131 away from the filter/attenuator 133, and the wavelength conversion device 12 is disposed between the lens 131 and the light source 11. Moreover, the light path of the wavelength-modulated blue light excited by the blue laser is denoted by the symbol “L1”, and the wavelength-modulated blue light is blue fluorescent light for example. The mixed blue light is received by the integrator rod 14 and used as the blue light source of the laser projector. To be noted, the wavelength-modulated blue light (e.g. blue fluorescent light) may be not as directional as the laser beam, and it may be divergent, so the light path denoted by “L1” just represents a part of the blue fluorescent light.

On the whole, when emitted by the light source 11, the blue laser enters the wavelength conversion device 12 to excite the blue fluorescent light. Then, according to the light path L of the blue laser and the light path L1 of the blue fluorescent light, the blue laser and the blue fluorescent light sequentially pass through the lens 131, the filter/attenuator 133 and the lens 132 and are concentrated and mixed on the integrator rod 14. Herein, when the blue laser excites the blue fluorescent light, the spectrum of the whole blue light mixing system encompasses the blue laser with the wavelength of 445 nm˜448 nm and the blue fluorescent light with the main wavelength of 460 nm±5 nm, and the portion of the blue laser will be partially filtered out/attenuated by the filter/attenuator. Hence, the obtained mixed blue light can fit the Rec. 709 standard, and the reduced laser energy can fit the security standard of the laser product (IEC-60825-1). In other words, the blue light mixing system is carried out by the minus approach of the transparent light path, wherein the extra laser energy is reduced by the filter/attenuator 133 and the mixed blue light can be obtained by mixing the blue laser and the blue fluorescent light and can be used as the blue light source of the laser projector.

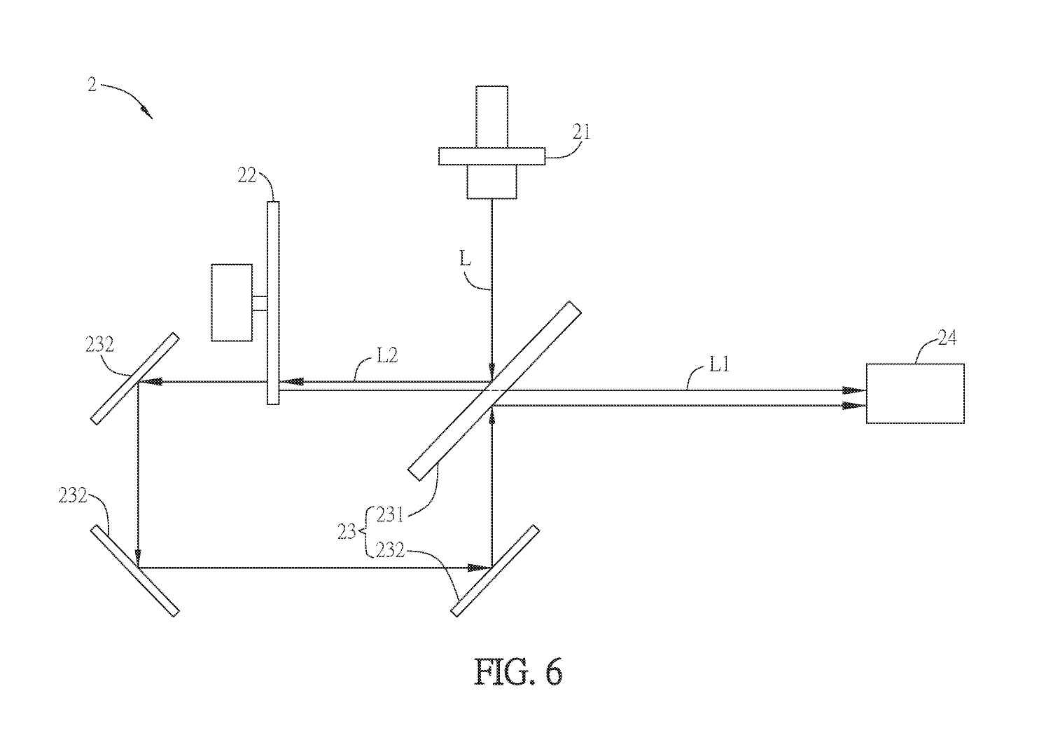

FIG. 6 is a schematic diagram of a blue light mixing system according to another embodiment of the invention. As shown in FIG. 6, the above mentioned blue light mixing method can be applied to the blue light mixing system 2. In this embodiment, the blue light mixing system 2 includes a light source 21, a wavelength conversion device 22, an optical element group 23 and an integrator rod 24. The light source 21, the wavelength conversion device 22 (as shown in FIG. 3B) and the integrator rod 24 can be comprehended by referring to the above embodiments, and therefore they are not described here for conciseness.

In this embodiment, the wavelength conversion device 22 is a color wheel and includes a transparent region. The following description can be comprehended also by FIG. 3B, which is a schematic diagram of the wavelength conversion device of this embodiment from the viewing angle of the incident direction of the light path L. The transparent region A can be formed, for example, by a transparent object such as glass or by a through hole, as long as it is permeable to light. In this embodiment, the wavelength conversion material can be disposed in the area (such as the region R) except the transparent region A, and the excited light through the wavelength conversion material is mainly blue light with the main wavelength of 460 nm±5 nm. Herein for example, the blue light is the blue fluorescent light with the main wavelength of 460 nm. As shown in FIG. 3B, the region S denotes the cross-section of the incident blue laser. When the blue laser is emitted to the edge of the transparent region A, a part of the blue laser will pass through and come out of the transparent region A, and another part of the blue laser will excite the blue fluorescent light. In this embodiment, the light path L1 of the blue fluorescent light is opposite to the light path L2 of the blue laser.

As shown in FIG. 6, in this embodiment, the optical element group 23 includes a dichroic mirror and a plurality of reflectors 232, which are all disposed on the light path L of the blue laser. The dichroic mirror 231 is used to reflect the blue laser, and the wavelength-modulated blue light (e.g. the blue fluorescent light) will pass through the dichroic mirror 231. As an embodiment, the dichroic mirror 231 is designed so as to reflect the light with the wavelength of 400 nm˜450 nm. Since the wavelength of the blue laser is 445 nm˜448 nm and the main wavelength of the blue fluorescent light is 460 nm±5 nm, the dichroic mirror 231 can reflect the blue laser and the blue fluorescent light will pass through the dichroic mirror 231.

On the whole, when the light source 21 emits the blue laser to the dichroic mirror 231, the dichroic mirror 231 reflects the blue laser to the wavelength conversion device 22. When the blue laser is emitted to the wavelength conversion device 22, a part of the blue laser passes through the transparent region and another part of the blue laser illuminate the wavelength conversion material to excite the blue fluorescent light, and the light path L1 of the blue fluorescent light is opposite to the light path L2 of the blue laser and passes through the dichroic mirror 231 to the integrator rod 24. Meanwhile, the portion of the blue laser coming out of the transparent region, as shown in FIG. 6, sequentially passes through the three reflectors 232 to go to the dichroic mirror 231. The dichroic mirror 231 reflects the reflected blue laser to the integrator rod 24 so that the mixed blue light can be generated. Herein, when a part of the blue laser excites the blue fluorescent light, the spectrum of the whole blue light mixing system encompasses the blue laser with the wavelength of 445 nm˜448 nm and the blue fluorescent light with the main wavelength of 460 nm±5 nm, and the portion of the blue laser coming out of the transparent region is reflected to the integrator rod 24 through several reflections to serve as the compensative light. Because a part of the blue laser is used as the excitation light source, the portion of the blue laser coming out of the transparent region has lower energy. Therefore, the mixed blue light with the spectrum as shown in FIG. 4C can fit the Rec. 709 standard, and the effectively reduced laser energy can fit the security standard of the laser product (IEC-60825-1). In other words, the blue light mixing system of this embodiment is carried out by the plus approach of the reflective light path, wherein the dichroic mirror is used to separate the light paths of the blue laser and the blue fluorescent light and the reflected blue laser is used as the compensative blue laser to be mixed with the blue fluorescent light. The mixed blue light is used as the blue light source of the laser projector.

Summarily, in the blue light mixing method and system of the invention, a part of the blue laser excites the wavelength-modulated blue light, and another part of the blue laser is mixed with the wavelength-modulated blue light to generate the blue light source fitting the Rec. 709 standard and the security standard of the laser product (IEC-60825-1).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A blue light mixing method, comprising steps of:
providing a blue laser;
disposing a wavelength conversion device on a light path of the blue laser, wherein a part of the blue laser excites the wavelength conversion device to emit a wavelength-modulated blue light; and
mixing the blue laser that hasn't undergone the wavelength modulation and the wavelength-modulated blue light.

2. The blue light mixing method as recited in claim 1, before the step of mixing light, further comprising a step of:
attenuating or partially filtering out the blue laser that hasn't undergone the wavelength modulation.

3. The blue light mixing method as recited in claim 1, wherein the wavelength conversion device includes a transparent region, and the wavelength conversion material is disposed in the area except the transparent region.

4. The blue light mixing method as recited in claim 3, wherein at least a part of the blue laser that hasn't undergone the wavelength modulation passes through the transparent region.

5. The blue light mixing method as recited in claim 3, wherein the wavelength conversion device includes a color wheel.

6. The blue light mixing method as recited in claim 3, wherein the wavelength conversion material includes a fluorescent material, a phosphorescent material or their combination.

7. The blue light mixing method as recited in claim 6, wherein the fluorescent material includes a silicone compound.

8. The blue light mixing method as recited in claim 1, wherein the wavelength of the blue laser is 445 nm˜448 nm, and the main wavelength of the wavelength-modulated blue light is 460 nm±5 nm.

9. A blue light mixing system, comprising:
a light source used to provide a blue laser;
a wavelength conversion device disposed on a light path of the blue laser; and
an optical element group forming the light path,
wherein a part of the blue laser excites the wavelength conversion device to emit a wavelength-modulated blue light, and the blue laser that hasn't undergone the wavelength modulation and the wavelength-modulated blue light are mixed.

10. The blue light mixing system as recited in claim 9, wherein the optical element group includes a filter used to partially filter out the blue laser, and the wavelength-modulated blue light passes through the filter.

11. The blue light mixing system as recited in claim 9, wherein optical element group includes an attenuator used to partially attenuate the blue laser, and the wavelength-modulated blue light passes through the attenuator.

12. The blue light mixing system as recited in claim 9, wherein optical element group includes a dichroic mirror used to reflect the blue laser, and the wavelength-modulated blue light passes through the dichroic mirror.

13. The blue light mixing system as recited in claim 9, wherein the wavelength conversion device includes a transparent region, and a wavelength conversion material is disposed in the area except the transparent region.

14. The blue light mixing system as recited in claim 13, wherein at least a part of the blue laser that hasn't undergone the wavelength modulation passes through the transparent region.

15. The blue light mixing system as recited in claim 13, wherein the wavelength conversion device includes a color wheel.

16. The blue light mixing system as recited in claim 13, wherein the wavelength conversion material includes a fluorescent material, a phosphorescent material or their combination.

17. The blue light mixing system as recited in claim 16, wherein the fluorescent material includes a silicone compound.

18. The blue light mixing system as recited in claim 9, wherein the wavelength of the blue laser is 445 nm˜448 nm, and the main wavelength of the wavelength-modulated blue light is 460 nm±5 nm.
